(19) United States
(12) Patent Application Publication
(10) Pub. No.: US 2026/0178300 A1
(43) Pub. Date: Jun. 25, 2026

(54) Method and Control System for a Technical Installation

(71) Applicant: Siemens Aktiengesellschaft, Muenchen (DE)

(72) Inventors: Benjamin LUTZ, Pfinztal (DE); Anna PALMIN, Karlsruhe (DE)

(21) Appl. No.: 19/127,485

(22) PCT Filed: Sep. 19, 2023
(86) PCT No.: PCT/EP2023/075708

§ 371 Date: May 6, 2025

(30) Foreign Application Priority Data
Nov. 7, 2022 (EP) 22205930.5

(51) Int. Cl. G06F 8/60; G06F 8/61; H04L 9/32; H04L 9/40

(52) U.S. Cl. CPC G06F 8/60; G06F 8/61; H04L 9/3263; H04L 9/3268; H04L 63/0823

(57) ABSTRACT

A control system for a technical installation, in particular a production or process installation, wherein the control system includes at least one operator station client configured to generate a graphical presentation for an operator of the technical installation based on the visualization information, at least one operator station server connected to the operator station client server and configured to transmit visualization information to the operator station client, and a container service implemented on the operator station server, which is configured to continuously receive a system image of a technical module for operating and observing the technical module, where the control system is configured to continuously add the system image to the graphical presentation for the operator of the technical system at runtime of the technical system, such that the integrity and authenticity of the system images and container application can be ensured by a corresponding protection mechanism.

### CROSS-REFERENCE TO RELATED APPLICATIONS

This is a U.S. national stage of application No. PCT/EP2023/075708 filed 19 Sep. 2023. Priority is claimed on European Application No. 22205930.5 filed 7 Nov. 2022, the content of which is incorporated herein by reference in its entirety.

### BACKGROUND OF THE INVENTION

### 1. Field of the Invention

The invention relates to a control system for a technical installation, in particular a production or process installation. The invention also relates to the use of a control system for operating a technical installation.

### 2. Description of the Related Art

Modern requirements for more flexibility and scalability of process engineering installations mean that components of installations are developed separately as small units, i.e., “package units” or “technical modules”. Complete process engineering installations are then created by combining individual package units. Batch systems on operator station servers, for example, are used to control and orchestrate the processes between the individual package units.

In addition to modularity in the development of package units, they also offer advantages with regard to the dynamics of a process engineering installation, for example, if, after the production of one batch, the installation is reorganized for the production of another batch (reallocation).

A package unit is a modular installation component that can be integrated in a central engineering system as a self-contained unit. Package units are more comprehensive than measuring points or technical facilities. Sometimes a package unit is even an entire partial installation of a complete process engineering structure that comprises a plurality of technical facilities (e.g., tanks), which in turn contain a plurality of measuring points (e.g., valves, monitors, regulators, and/or motors).

The following problem is encountered with conventional control systems for orchestrating technical modules or package units: the installation images of the orchestration are usually generated when importing a description of the package unit into an engineering environment of a control system in the respective technology for operating and monitoring the control system. The descriptions of the installation images, for example, when using the MTP standard VDI/VDE/NAMUR 2658 (Module Type Package), are often very generic and have a smaller number of objects compared to conventional control systems. As a result, extensive manual reworking and enhancement is often necessary after generation. Moreover, the process described must be repeated for each installation in which the package unit is to be used.

EP 3 712 730 A1 discloses a method for orchestrating individual technical modules for operating a process installation.

### SUMMARY OF THE INVENTION

In view of the foregoing, it is an object of the invention to provide a control system for a technical installation that increases the efficiency and flexibility of the operation and monitoring of a technical installation operated with technical modules.

This and other objects and advantages are achieved in accordance with the invention by a control system, by a technical system, a technical module, by the use of the control system for operating a technical installation, by the use of the technical system for operating the technical installation and by the use of the technical module for operating the technical installation.

The control system in accordance with the invention for a technical installation, in particular a production or process installation, comprises at least one operator station server and at least one operator station client connected to the operator station server, where the operator station server is configured to transmit visualization information to the operator station client, and wherein the operator station client is configured to generate a graphical presentation for an operator of the technical installation based on the visualization information.

The inventive control system includes a container service implemented on the operator station server, which is configured to reference a technical module with an installation image for operating and monitoring the technical module and to continuously receive the installation image from the technical module, where the control system is configured to continuously add the installation image to the graphical presentation for the operator of the technical installation at a runtime of the technical installation.

The technical installation can be an installation from the process industries, for example a chemical, pharmaceutical, petrochemical installation or an installation from the food and beverage industries. This also includes any installations from production industries, factories in which, for example, automobiles or goods of all kinds are produced. Technical installations suitable for performing the method in accordance with the invention can also come from the field of power generation. Wind turbines, solar installations or power plants for power generation are also covered by the term technical installation.

In the present context, a control system should be understood to be a computer-aided technical system with functionalities for displaying, operating and controlling the technical installation. The control system can also comprise sensors for ascertaining measured values and various actuators. In addition, the control system can comprise so-called process-oriented or production-oriented components that serve to actuate the actuators or sensors. Moreover, the control system can, inter alia, have means for visualizing the process engineering installation and for engineering. The control system can optionally also comprise further computing units for more complex regulation systems and systems for data storage and data processing.

In accordance with the present disclosure, an “operator station server” should be understood to be a server that centrally acquires data from an operating and monitoring system and, as a rule, alarm and measured value archives of a process control system of a technical installation and makes the data available to users. As a rule, the operator station server establishes a communication link to automation systems of the technical installation and forwards data from the technical installation to operator station clients that serve to operate and monitor operation of the individual functional elements of the technical installation.

The operator station server can have client functions to access data (archives, messages, tags, variables) from other operator station servers. This enables images of an operation of the technical installation on the operator station server to be combined with variables from other operator station servers (server-server communication). The operator station server can be, but is not limited to, a SIMATIC PCS 7 Industrial Workstation Server made by SIEMENS.

The control system is configured to visually display the installation image from the technical module, where the installation image represents the technical module for operating and monitoring the technical installation. In the case of a technical module for a process installation, such an installation image can, for example, comprise graphical representations of pumps, valves, tanks, pipelines, and/or combustion chambers. Herein, the graphical representations can comprise, e.g., current process measured values, status values, and/or (alarm) messages.

The control system in accordance with the invention provides a container service that enables the operator of a control system to access the operation and monitoring of the technical module in a suitable form.

In contrast to conventional control systems, herein the installation image for operating and monitoring the technical module is not (permanently) integrated into the project planning software as part of the project planning for the technical installation. Instead, the installation image (or installation images) is provided as a central interface for the operator for operating and monitoring the technical module on the technical module itself. This means that the associated application is executed by the technical module, but not by the control system or its operator station server.

For this purpose, the control system in accordance with the invention provides a corresponding container (service), which references the installation image of the technical module and receives it continuously. Herein, ‘continuously’ means that the installation image from the technical module is continuously updated and transmitted to the container service on the operator station server, in particular at specific time steps. A connection based on the Open Platform Communications Unified Architecture (OPC UA) standard, for example, can be used for data exchange between the technical module and the control system or its operator station server.

The invention offers the advantage that it is possible to dispense with installation images for the orchestration of the technical module (or technical modules) that may have been imported into the control system and modified and that may be afflicted with errors. In particular, technical modules that contain extensive automation hardware due to their configuration, for example, operator station servers, can be integrated into a common orchestration more easily and with error-minimized integration effort by the control system according to the invention. Moreover, the control system in accordance with the invention can be an important component in the realization of “Plug & Produce” solutions in which the orchestration effort is to be minimized in the context of the integration of technical modules into a control system.

Preferably, the control system is configured to receive an input from the operator relating to the installation image via the operator station client at a runtime of the technical installation and to transmit it to the container service on the operator station server, where the container service is configured to transmit the input from the operator to the technical module, and where the input is particularly configured to control a technical functionality of the technical module.

The container service enables the operator to make an input in the graphical presentation (i.e., the graphical interface for operating and monitoring the technical installation) provided by the operator station client, where this input relates to the installation image of the technical module. For this purpose, the container service can, for example, create a window in the graphical presentation in which the installation image is displayed in a familiar manner. This enables the operator to perform all the usual operations for operating and monitoring installation images, as if the installation image were calculated and made available directly by the control system. However, the difference to conventional control systems is that the input from the operator, for example, adjusting a regulator or changing a parameter, does not relate to an installation image generated by the control system itself, but relates to one generated by the technical module.

In a preferred embodiment of the invention, the container service is configured to receive, in addition to the installation image, further information associated with the installation image from the technical module and, in particular in response to a request from the operator, to store it in a computer-implemented memory of the control system. Herein, the container service can receive the additional information via a corresponding interface and make it available for processing to both the memory and further possible components or services of the control system.

The information is preferably alarm messages, where the control system is configured to integrate the alarm messages into an alarm management system of the control system. As a result, the operator can easily obtain a direct overview of possible alarms occurring within the technical module. Herein, an alarm message is a message that as a rule requires an immediate response from an operator. Herein, a message should be understood to be a report of the occurrence of an event that represents a transition from one discrete state within the technical module to another discrete state.

The above-described objects and advantages are also achieved in accordance with the invention by a technical system comprising a control system in accordance with the disclosed embodiments and by a technical module connected thereto, where a container application is implemented in an executable manner in a computing environment of the technical module, during the execution of which the installation image associated with the technical module is continuously transmitted to the container service of the control system for operating and monitoring the technical module. The installation image (or installation images) required for the operation and monitoring is generated and continuously updated on the technical module itself. A container application of the technical module makes the installation image available to the container service of the control system, such as via an OPC UA connection.

Preferably, the operator station server of the control system includes a digital map of the technical installation and the technical module includes a digital map of the technical module, where the control system and the technical module are each configured to continuously synchronize the respective digital maps with one another, in particular in fixed time steps. In the case of a process installation or a technical module for a process installation, the current process measurement values, status and other information relating to the individual process devices are mapped in such digital images. The synchronization, inter alia, enables common archiving or automatically coordinated orchestration via flowcharts or scripts by the orchestrated operator station server of the control system.

In a preferred embodiment of the invention, the installation image transmitted from the technical module to the container service of the control system and the container application implemented in an executable manner in the computing environment of the technical module have a protective mechanism for verifying their identity, integrity and authenticity. Preferably, the identity and integrity of the installation image and the container application implemented in the computing environment of the technical module are checked each time the installation image is retransmitted to the container service of the control system.

Herein, the protective mechanism can comprise a private key securely stored in the technical module, an identification certificate issued by a manufacturer or user of the technical module and made available to the container service of the control system, and a certificate chain, where the certificate chain comprises:
a certificate from a certification body that issued the identification certificate,
a certificate from a root certification authority superior to the certification body, and, if applicable,
certificates from intermediate certification authorities, located in the certificate chain between the certification body and the root certification authority.

One possible mode of operation of the protective mechanism is as follows: after each update of the installation image, the installation image is signed using the aforementioned certificate. Here, it should be noted that the aforementioned certificate in particular contains the public key for the aforementioned private key. This means that the aforementioned signature can be validated by default (according to RFC 5280) using the aforementioned certificate and in particular the public key contained in the certificate and the associated certificate chain. Signature validation is used to check the integrity and authenticity of the installation image. If it is determined that the signature is invalid or does not match the installation image, then this indicates unauthorized tampering. In this case, the installation image is rejected as having been tampered with without authorization.

Each time the installation image that has been signed (as explained above), using the private key stored in the technical module, is made available, the container service validates the integrity and authenticity of the installation image by validating the signature using the associated public key and the associated certificate chain.

In addition, the identity, integrity and authenticity of the aforementioned container application, which makes the installation image available to the container service, can be checked by the container service in an identical manner each time the installation image is made available. Similarly to the private key used to sign the installation image, a private key securely stored in the technical module is required for this, where the public key required for signature validation is contained in an associated certificate issued by a trustworthy body (such as the manufacturer or user of the module). Furthermore, each body that is to validate the signature must have access to the associated certificate chain.

In one possible execution scenario, the same private key can be used to sign installation images and to sign the container application. However, other scenarios are also conceivable, for example using different private keys.

In a further possible execution scenario, the “IDevID” certificate (in accordance with Institute of Electrical and Electronics Engineers (IEEE) standard 802.1AR), as the “manufacturer-issued identification certificate” for the module, can be used to sign the installation images and/or the container application. Alternatively, in a further execution scenario, the “LDevID” certificate (in accordance with IEEE standard 802.1AR) issued by the user/operator of the module can be used for this purpose.

The objects and advantages are also achieved in accordance with the invention by a technical module, which has a computing environment in which a container application is implemented in an executable manner, during the execution of which an installation image associated with the technical module for operating and monitoring the technical module can be continuously transmitted to a container service of a control system that can be connected to the technical module.

Preferably, the technical module is configured to transmit, in addition to the installation image, further information associated with the installation image from the technical module to the control system. The information can be alarm messages.

Most preferably, the technical module is configured to receive from the control system an input from an operator relating to the installation image, where the input is particularly configured to control the operation of a technical functionality of the technical module.

The objects and advantages are also achieved in accordance with the invention by the use of a control system in accordance with disclosed embodiments for operating a technical installation, in particular a production or process installation.

The objects and advantages are also achieved in accordance with the invention by the use of a technical system in accordance with disclosed embodiments for operating a technical installation, in particular a production or process installation.

The objects and advantages are further achieved by the use of a technical module in accordance with disclosed embodiments for operating a technical installation, in particular a production or process installation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which they are achieved will become clearer and more plainly comprehensible in connection with the following description of exemplary embodiments, which will be explained in more detail in connection with the drawings, in which:

FIG. 1 is a schematic block diagram of an object model of a technical module in accordance with the invention;

FIG. 2 is a schematic block diagram of an aspect of a technical system in accordance with the invention; and

FIG. 3 a schematic block diagram of a control system in accordance with the invention.

### DETAILED DESCRIPTION OF THE EXEMPLARY EMBODIMENTS

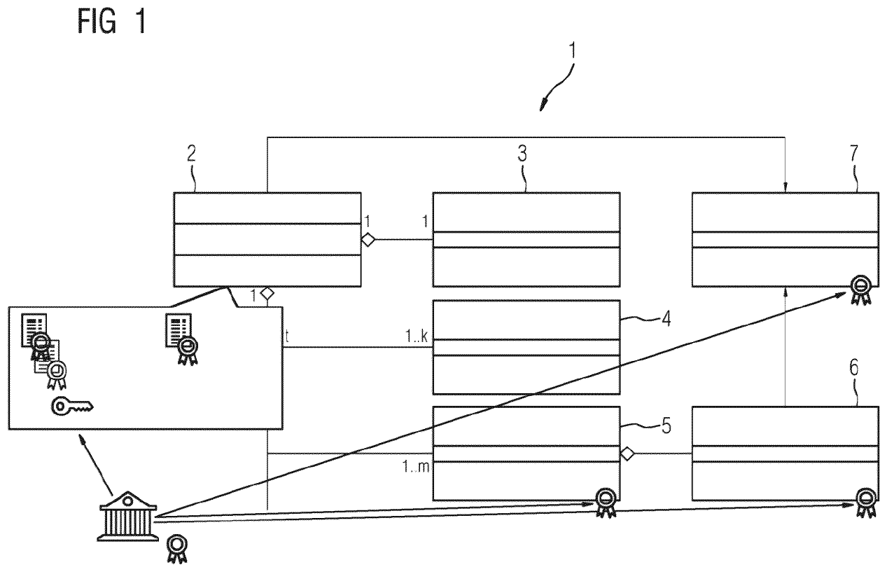

FIG. 1 shows an object model 1 of a technical module 2. The technical module 2 has an interface definition 3 and 1..k components 4, which each have a technical functionality. For example, a component 4 can be a stirrer with a stirring functionality, a heater with a heating functionality or a mixer with a mixing functionality. The interface definition 3 contains, inter alia, information about how data can be exchanged with the technical module 2.

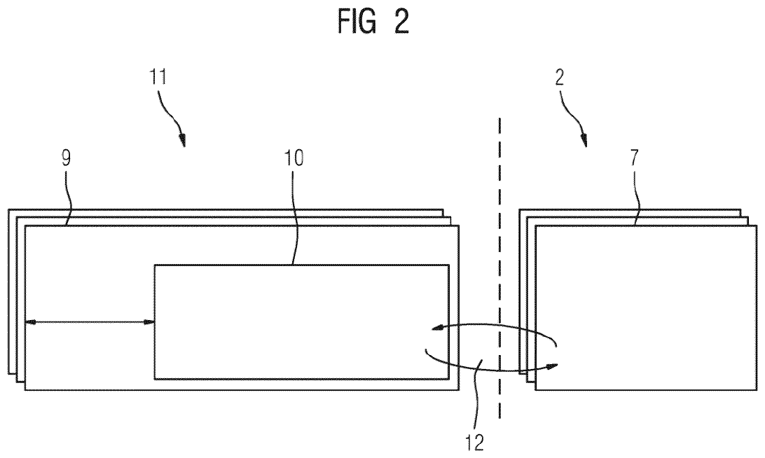

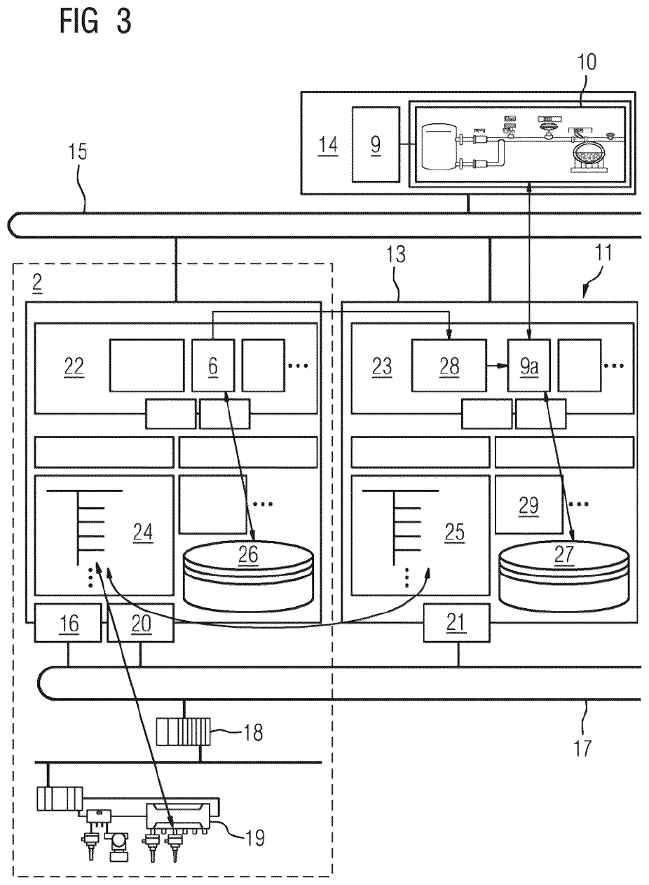

1..m installation images 5 are projected in the technical module 2, which each enable a partial aspect of the technical functionality of the technical module 2 to be operated and monitored. The technical module has a container application 6 that references an installation image service 7 of the technical module 2. In conventional technical modules, the installation images 5 are transmitted together with further descriptions of the technical module 2 to a superior orchestration body (such as a control system). However, in the present case, the container application 6 only generates a container, i.e., a type of empty installation image, which is provided with a reference to the installation image service 7. If the container is integrated by a control system into its operation and monitoring, then the control system can thereby access the installation image generated and continuously updated by the installation image service 7 of the technical module 2 for operating and monitoring the technical module 2 (see FIG. 2 and FIG. 3).

A certification body 8 of the manufacturer/user/operator of the technical module 2 has provided the technical module 2 with a certificate issued for the private key securely stored in the technical module and the associated certificate chain. Herein, the specifications in accordance with IEEE 802.1AR may have been applied with regard to the aforementioned private key.

This private key can be used in combination with the public key contained in the associated certificate to protect the integrity/authenticity of the installation images and/or the container application. As explained above, a plurality of private keys can be used for different purposes.

FIG. 2 shows the interaction between the technical module 2 and a control system 11. The control system 11 has an installation image display service 9, which (inter alia) provides a variable display element 10. The information received by the container application 6 of the technical module 6 is converted in this display element 10. Specifically, this means that the installation image provided (“hosted”) by the installation image service 7 of the technical module 2 is displayed graphically so that an operator of the control system 11 can operate and monitor the technical module 2 via this. The bidirectional connection 12 established between the technical module 2 and the control system 11 can be configured in accordance with the OPC UA standard, where mutual authentication, i.e., a check of integrity and authenticity, is included.

In FIG. 3, the control system 11 for operating and monitoring a technical installation configured as a process installation is shown schematically on the right-hand side of the image. The control system 11 comprises an operator station server 13 and an operator station client 14. The operator station server 13 and the operator station client 14 are connected to one another via a terminal bus 15 and optionally to further components (not shown) of the control system 11, such as an archive server or an engineering station server.

A user or operator can access the operator station server 13 for the purposes of operating and monitoring via the operator station client 14 using the terminal bus 15. The terminal bus 15 can, without being limited thereto, be formed as an Industrial Ethernet.

The left-hand side of the image in FIG. 3 shows the technical module 2. The technical module 2 also has a connection to the terminal bus 15. The technical module 2 has a device interface 16, which is connected to an installation bus 17. This device interface 16 connects the technical module 2 to an automation device 18 and to further components of the process engineering installation, such as peripheral devices 19, and can communicate therewith. The installation bus 17 can, without being limited thereto, be formed as an Industrial Ethernet, for example.

The technical module 2 and the operator station server 13 of the control system 11 have an OPC UA interface 20, 21, in each case connected to the installation bus 17. A visualization service 22, 23, a process map 24, 25 and a memory 26, 27 are (inter alia) implemented on the operator station server 13 and the technical module 2.

The visualization service 23 integrated in the operator station server 13 initiates the transmission of visualization information to the operator station client 14. The operator station client 14 is configured to display a visualization, i.e., a graphical presentation, in particular of installation images, for operating and monitoring the process installation.

In each case, a snapshot of the (signal) states of the connected devices and/or applications is stored in the process map 24, 25. The process maps 24, 25 of the technical module 2 and the control system 11 are continuously synchronized with one another via the OPC UA interfaces 20, 21.

The container application 6 provides a container service 28 of the control system 11 with the empty container containing the reference to the installation image provided by the installation image service 7 of the technical module 2. The container service 28 transmits this information to both the memory 27 and the installation image display service 9a, 9, which consists of a server part 9a and a client part 9. The installation image display service 9a, 9 then graphically displays the window application 10 with the installation image of the technical module 2 referenced therein for an operator of the control system 11.

An alarm service 29 of the control system 11 accesses the information stored in the memory 27 relating to the installation image of the technical module 2 and extracts any alarm messages therefrom. These are transmitted back to the operator station client 14 in order to provide the operator with visual and, if necessary, acoustic notifications of the alarm messages associated with the technical module 2.

Operator input relating to the installation image, which the operator can make directly in the window application 10, is transmitted to the container application 6 of the technical module 2 via the container service 28 of the control system 1. The actions requested by the operator are then performed in the technical module 2. In particular, herein, the operator can request the technical functionality of one of the components 4 of the technical module 2.

Although the invention has been illustrated and described in detail by the preferred exemplary embodiment, the invention is not restricted by the disclosed examples and other variations can be derived therefrom by the person skilled in the art without departing from the scope of protection of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A technical system comprising a control system for a technical installation, the control system comprising:
at least one operator station client configured to generate a graphical presentation for an operator of the technical installation based on the visualization information;
at least one operator station server connected to the operator station client, the at least one operator station server being configured to transmit visualization information to the operator station client;
a container service implemented on the operator station server, said container service being configured to continuously receive an installation image from a technical module for operating and monitoring the technical module, the control system being configured to continuously add the installation image to the graphical presentation for the operator of the technical installation at a runtime of the technical installation; and
a technical module connected to the control system, a container application being implemented in an executable manner in a computing environment of the technical module, the installation image associated with the technical module being continuously transmitted to the container service of the control system for operating and monitoring the technical module during the execution of the container application;
wherein the installation image transmitted from the technical module to the container service of the control system and the container application implemented in an executable manner in the computing environment of the technical module include a protective mechanism for identity and integrity verification;
wherein the protective mechanism comprises a private key securely stored in the technical module, an identification certificate issued by a manufacturer or user of the technical module and made available to the container service of the control system and an associated certificate chain; and
wherein the certificate chain comprises:
a certificate from a certification body which issued the certificate,
a certificate from a root certification authority superior to the certification body, and, when applicable, and
certificates from intermediate certification authorities located in the certificate chain between the certification body and the root certification authority.

17. The technical system as claimed in claim 16, wherein the control system is configured to receive an input from the operator relating to the installation image via the operator station client at a runtime of the technical installation and to transmit said received input to the container service on the operator station server; wherein the container service is configured to transmit the input from the operator to the technical module; and wherein the input is configured to control a technical functionality of the technical module.

18. The technical system as claimed in claim 16, wherein the container service of the control system is configured to receive, in addition to the installation image, further information associated with the installation image from the technical module and, in response to a request from the operator, to store the received further information in a computer-implemented memory of the control system.

19. The technical system as claimed in claim 17, wherein the container service of the control system is configured to receive, in addition to the installation image, further information associated with the installation image from the technical module and, in response to a request from the operator, to store the received further information in a computer-implemented memory of the control system.

20. The technical system as claimed in claim 18, wherein the information comprises alarm messages; and wherein the control system is further configured to integrate the alarm messages into an alarm management system of the control system.

21. The technical system as claimed in claim 16, wherein the at least one operator station server of the control system includes a digital map of the technical installation and the technical module includes a digital map of the technical module; and wherein the control system and the technical module are each configured to continuously synchronize respective digital maps with one another.

22. The technical system as claimed in claim 21, wherein continuous synchronization occurs in fixed time steps.

23. The technical system as claimed in claim 16, wherein the technical installation is operated by the technical system.

24. The technical system as claimed in claim 23, wherein technical installation is a production or process installation.

25. The technical system as claimed in claim 16, wherein the technical installation is a production or process installation.
